(19) United States
(12) Patent Application Publication
(10) Pub. No.: US 2025/0015824 A1
(43) Pub. Date: Jan. 9, 2025

(54) HELMET POWER AND COMMUNICATIONS HUB

(71) Applicant: OTTO ENGINEERING, INC., Carpentersville, IL (US)

(72) Inventors: Ken Jillson, Bloomfield Hills, MI (US); Daniel F. Stanek, Chicago, IL (US)

(21) Appl. No.: 18/377,382

(22) Filed: Oct. 6, 2023

Related U.S. Application Data
(60) Provisional application No. 63/414,146, filed on Oct. 7, 2022.

(51) Int. Cl. H04B 1/3827; H04W 4/10

(52) U.S. Cl. CPC H04B 1/385; H04W 4/10; H04B 2001/3866

(57) ABSTRACT

Various embodiments provide a helmet power and communications hub detachably coupled to a tactical helmet for providing wired communication and/or power to helmet-attached accessories and communication headsets, and for providing wireless communication with body-worn accessories. The helmet power and communications hub includes a communications headset interface configured to receive a wired connection with a communication headset. The helmet power and communications hub includes a night vision device interface configured to receive a wired connection with a night vision device. The helmet power and communications hub includes universal serial bus (USB) ports configured to receive a wired connection with helmet worn accessories. The helmet power and communications hub includes a wireless radio disposed within a housing and configured to wirelessly connect to a corresponding wireless radio of a push-to-talk (PTT) switch. The helmet power and communications hub includes a battery unit configured to power the helmet power and communications hub.

### CROSS-REFERENCE TO RELATED APPLICATIONS/INCORPORATION BY REFERENCE

The present application claims priority under 35 U.S.C. § 119(e) to U.S. Provisional Application No. 63/414,146, filed on Oct. 7, 2022, and entitled “POWERED WIRELESS HELMET COMMUNICATION HUB MODULE DEVICES, SYSTEMS, AND METHODS OF USE THEREOF,” which is hereby incorporated herein by reference in its entirety.

### FIELD

Certain embodiments relate to the tactical helmets, helmet-attached accessories, body-worn accessories, and audio communications systems. More specifically, certain embodiments relate to a power and communications hub detachably coupled to a tactical helmet for providing wired communication and/or power to helmet-attached accessories and communication headsets, and for providing wireless communication with body-worn accessories.

### BACKGROUND

Military, law enforcement, first responders, and the like routinely wear tactical helmets with attached communications systems, cameras, visual displays, sensors and/or lights, among other things. These helmet-attached devices are often communicatively coupled by cables to body-worn devices, such as push-to-talk (PTT) switch devices, end user devices (EUDs), and the like. The cables communicatively coupling the helmet-attached devices to the body-worn devices may create physical interference, snag hazards, and/or can be general uncomfortable for the users. Additionally, the helmet-attached devices may each include batteries of different sizes that operate in isolation, resulting in additional weight that may be imbalanced on the tactical helmet.

Further limitations and disadvantages of conventional and traditional approaches will become apparent to one of skill in the art, through comparison of such systems with some aspects of the present disclosure as set forth in the remainder of the present application with reference to the drawings.

### BRIEF SUMMARY

A helmet power and communications hub is provided, substantially as shown in and/or described in connection with at least one of the figures, as set forth more completely in the claims.

These and other advantages, aspects and novel features of the present disclosure, as well as details of an illustrated embodiment thereof, will be more fully understood from the following description and drawings.

### BRIEF DESCRIPTION OF SEVERAL VIEWS OF THE DRAWINGS

FIG. 1 is a block diagram of an exemplary system comprising a helmet power and communications hub, in accordance with various embodiments.

FIG. 2 is a front elevation view of an exemplary helmet power and communications hub, in accordance with various embodiments.

FIG. 3 is a front, side perspective view of an exemplary helmet power and communications hub, in accordance with various embodiments.

FIG. 4 is a front, top perspective view of an exemplary helmet power and communications hub, in accordance with various embodiments.

FIG. 5 is a front, bottom perspective view of an exemplary helmet power and communications hub, in accordance with various embodiments.

FIG. 6 is a rear, side perspective view of an exemplary helmet power and communications hub, in accordance with various embodiments.

### DETAILED DESCRIPTION

Certain embodiments may be found in a helmet power and communications hub detachably coupled to a tactical helmet for providing wired communication and/or power to helmet-attached accessories and communication headsets, and for providing wireless communication with body-worn accessories. Aspects of the present disclosure provide the technical effect of providing wireless communications between a communications headset and a body-worn push-to-talk (PTT) switch or radio. Various embodiments provide the technical effect of providing wireless communications between a body-worn end user device (EUD) and helmet-attached accessories, such as night vision devices, video cameras, infrared beacons, strobe lights, flashlights, sensors (e.g., blast pressure sensors, chemical biological radiological nuclear (CBRN) sensors, etc.), visual displays, and the like. Certain embodiments provide the technical effect of improving a balance of a tactical helmet by positioning a helmet power and communications hub on a rear side of the tactical helmet as a counterbalance to other helmet-attached accessories mounted on a front of the tactical helmet, such as night vision devices (i.e., googles or monocles), visual displays, video cameras, lights, and the like. Aspects of the present disclosure providing the technical effect of consolidating battery power and controlling power distribution from a centralized helmet power and communications hub device.

The foregoing summary, as well as the following detailed description of certain embodiments will be better understood when read in conjunction with the appended drawings. To the extent that the figures illustrate diagrams of the functional blocks of various embodiments, the functional blocks are not necessarily indicative of the division between hardware circuitry. Thus, for example, one or more of the functional blocks (e.g., processors or memories) may be implemented in a single piece of hardware (e.g., a general purpose signal processor or a block of random access memory, hard disk, or the like) or multiple pieces of hardware. Similarly, the programs may be stand alone programs, may be incorporated as subroutines in an operating system, may be functions in an installed software package, and the like. It should be understood that the various embodiments are not limited to the arrangements and instrumentality shown in the drawings. It should also be understood that the embodiments may be combined, or that other embodiments may be utilized and that structural, logical and electrical changes may be made without departing from the scope of the various embodiments of the present disclosure. The following detailed description is, therefore, not to be taken in a limiting sense, and the scope of the present disclosure is defined by the appended claims and their equivalents.

As used herein, an element or step recited in the singular and proceeded with the word “a” or “an” should be understood as not excluding plural of said elements or steps, unless such exclusion is explicitly stated. Furthermore, references to “an embodiment,” “one embodiment,” “a representative embodiment,” “an exemplary embodiment,” “various embodiments,” “certain embodiments,” and the like are not intended to be interpreted as excluding the existence of additional embodiments that also incorporate the recited features. Moreover, unless explicitly stated to the contrary, embodiments “comprising,” “including,” or “having” an element or a plurality of elements having a particular property may include additional elements not having that property.

Furthermore, the term controller, processor, processing unit, microcontroller unit, and the like, as used herein, refers to any type of processing unit that can carry out the required calculations needed for the disclosure, such as single or multi-core: central processing unit (CPU), digital signal processor (DSP), field programmable gate array (FPGA), application-specific integrated circuit (ASIC), or a combination thereof.

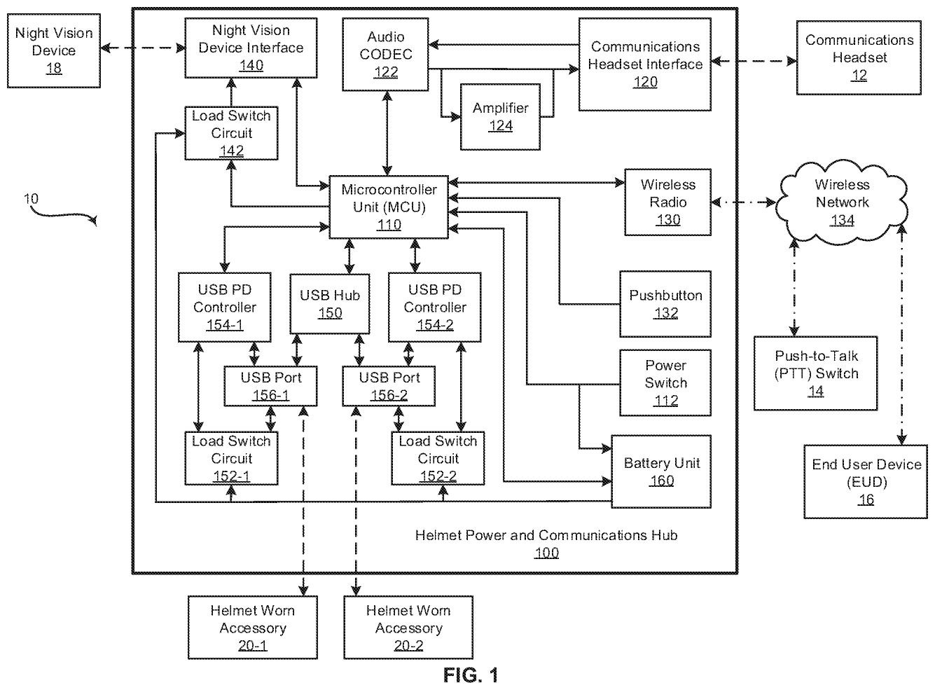

FIG. 1 is a block diagram of an exemplary system 10 comprising a helmet power and communications hub 100, in accordance with various embodiments. Referring to FIG. 1, the system 10 comprises a helmet power and communications hub 100, a communications headset 12, a push-to-talk (PTT) switch 14, an end user device (EUD) 16, a night vision device 18, and helmet worn accessories 20-1, 20-2, among other things.

The communications headset 12 may comprise a microphone and speakers. The microphone may be configured to convert sound to electrical audio signals wirelessly communicated by the helmet power and communications hub 100 to a PTT switch device 14 or radio device for transmission during a transmit mode. The speakers may be configured to receive electrical audio signals from a PTT switch device 14 or radio device via the helmet power and communication hub 100 during a receive mode, and to convert the electrical audio signals to sound that is output to a user.

The PTT switch device 14 may be implemented as a junction to connect one or more radios to a single user's communications headset 12. The PTT switch device 14 may be configured to independently activate each radio's transmit function and allow the user to transmit audio from the microphone of the communications headset 12 through any of the connected radios via PTT switches. The PTT switch device 14 comprises a wireless radio configured to pair with a corresponding wireless radio 130 of the helmet power and communication hub 100 to transmit and receive audio via a wireless network 134. The wireless network 134 may support communication of digital information using any suitable wireless access technology including, for example, any combination of Intra Soldier Wireless (ISW), Bluetooth, Bluetooth Low Energy (BLE), ultra-wideband (UWB), 900 MHz, 2.4 GHz, 5.4 GHz, short-range, long range, Wi-Fi, cellular, personal communication system (PCS), and/or any suitable air interface technology. In certain embodiments, the wireless network 134 may be a personal area network (PAN) or any suitable network. The electrical audio signals received from the PTT switch 14 by the helmet power and communication hub 100 is provided to the connected communications headset 12. The electrical audio signals received from the communications headset 12 by the helmet power and communication hub 100 is provided to the wirelessly connected PTT switch 14. Additionally and/or alternatively, one of the radios may include a wireless radio paired via the wireless network 134 with the wireless radio 130 of the helmet power and communication hub 100 to facilitate communications between the radio and the communications headset 12.

The end user device (EUD) 16 may be a smartphone, tablet, and/or any suitable mobile computing device. The EUD 16 may be a body-worn device comprising a wireless radio configured to pair with a corresponding wireless radio 130 of the helmet power and communication hub 100 via the wireless network 134 to transmit digital control signals to, and receive digital data signals from, the night vision device 18 and/or helmet worn accessories 20-1, 20-2 electrically connected to the helmet power and communications hub 100. The EUD 16 may be operated by a user to select and/or modify settings of the helmet power and communications hub 100, the night vision device 18, and/or the helmet worn accessories 20-1, 20-2. For example, the EUD device 16 may be configured to set the power control settings of the helmet power and communications hub 100 to select whether connected devices 18, 20-1, 20-2 will receive power from the helmet power and communications hub 100. As another example, the EUD device 16 may define display settings of the night vision device 18 and/or helmet-worn visual displays. The EUD device 16 may define an intensity, focus, strobe pattern, or the like of connected lighting devices, such as strobe lights, flashlights, infrared beacons, and the like. The EUD device 16 may define a frame rate, brightness, contrast, and the like of video captured by an attached video camera.

The night vision device 18 may be night vision googles (NVG), enhanced night vision googles (ENVG), a night vision monocle (NVM), or any suitable night vision device. The night vision device 18 may be attached to a front portion of a tactical helmet and electrically connected to a night vision device interface 140 of the helmet power and communications hub 100. The night vision device 18 may be configured to receive power from the helmet power and communications hub 100. In various embodiments, the night vision device 18 may be configured to receive control signals from, and provide data to, the end user device (EUD) 16 via the helmet power and communications hub 100.

The helmet worn accessories 20-1, 20-2 may include video cameras, infrared beacons, strobe lights, flashlights, sensors (e.g., blast pressure sensor, chemical biological radiological nuclear (CBRN) sensor, etc.), visual displays, and/or any suitable helmet worn accessories 20-1, 20-2. The helmet worn accessories 20-1, 20-2 may be attached to front, side, and/or top portions of the tactical helmet and electrically connected to USB ports 156-1, 156-2 of the helmet power and communications hub 100. The helmet worn accessories 20-1, 20-2 may be configured to provide to and/or receive power from the helmet power and communications hub 100. In various embodiments, the helmet worn accessories 20-1, 20-2 may be configured to receive control signals from, and provide data to, the end user device (EUD) 16 via the helmet power and communications hub 100.

The helmet power and communications hub 100 comprises a power switch 112, a microcontroller unit (MCU) 110, a communications headset interface 120, a wireless radio 130, a night vision device interface 140, a plurality of universal serial bus (USB) ports 156-1, 156-2, and a battery unit 160, among other things. The helmet power and communications hub 100 may be configured to be detachably coupled to a back portion of a tactical helmet to provide a counterbalance to the night vision device 18 and/or any helmet worn accessories 20-1, 20-2 mounted to a front portion of the tactical helmet. For example, the helmet power and communications hub 100 may be detachably coupled to the tactical helmet by hook and loop fasteners, snaps, adhesive tape, and/or any suitable fastener. The helmet power and communications hub 100 may be communicatively coupled to the communications headset 12, night vision device 18, and/or any other helmet worn accessories 20-1, 20-2 by wired connections. The helmet power and communications hub 100 may be communicatively coupled to body worn devices, such as a PTT switch 14, radios, EUDs 16, or the like, via a wireless connection.

The power switch 112 of the helmet power and communications hub 100 may be a mechanical rocker switch, or any suitable switch. The power switch 112 is a power disconnect configured to turn on and off the power supplied from the battery unit 160 to the MCU 110, communications headset interface 120, wireless radio 130, night vision device interface 140, and USB ports 156-1, 156-2.

The MCU 110 of the helmet power and communications hub 100 may be one or more central processing units, microprocessors, microcontrollers, and/or the like. The MCU 110 may be an integrated component, or may be distributed across various locations, for example. The MCU 110 may be capable of managing the power provided by the battery unit 160 to connected devices 18, 20-1, 20-2, processing audio signals transmitted between the communications headset 12 and the PTT switch 14 or radio device, and facilitating communication of control signals and data between the EUD 16 and connected devices 18, 20-1, 20-2, among other things. The MCU 110 may be capable of executing any of the method(s) and/or set(s) of instructions discussed below in accordance with various embodiments of the present technology, for example. The MCU 110 comprise or be communicatively coupled to a memory (not shown, which may be one or more computer-readable memories, for example, such as a disk, compact storage, flash memory, random access memory, read-only memory, electrically erasable and programmable read-only memory and/or any suitable memory. The memory may include databases, libraries, sets of information, or other storage accessed by and/or incorporated with the MCU 110, for example. The memory may be able to store data temporarily or permanently, for example. The memory may be capable of storing data generated by the MCU 110 and/or instructions readable by the MCU 110, among other things.

The MCU 110 may comprise suitable logic, circuitry, interfaces, and/or code that is configured to facilitate communications between a communications headset 12 and a PTT switch 14 or radio. The MCU 110 may provide audio signals received from the PTT switch 14 or radio via the wireless radio 130 to the communications headset 12. For example, the MCU 110 may receive digitized audio signals from the wireless radio 130. The digitized audio signals are processed by the MCU 110 and provided to an audio CODEC 122, which comprises suitable logic, circuitry, interfaces, and/or code that is operable to convert the digitized audio signals received from the MCU 110 to analog audio signals. The analog audio signals may optionally be provided to an amplifier 124, which comprises suitable logic, circuitry, interfaces, and/or code that is operable to amplify the analog audio signals. Alternatively, the audio CODEC 122 may provide the analog audio signals to the communications headset interface 120 without amplification. The analog audio signals are output to the communications headset 12 via the communications headset interface 120. The communications headset interface 120 is operable to receive a wired connection from the communications headset 12, such as a plug of a communications cable. The communications headset interface 120 is configured to provide analog audio signals to, and receive analog audio signals from, the communications headset 12. The communications headset interface 120 may receive analog audio signals from the communications headset 12, which are provided to the audio CODEC 122. The audio CODEC 122 comprises suitable logic, circuitry, interfaces, and/or code that is operable to convert the analog audio signals received from the communications headset interface 120 to digitized audio signals. The digitized audio signals are provided to the MCU 110, which processes the digitized audio signals and provides the digitized audio signals to the wireless radio 130 for wireless transmission to the PTT switch 14 or a radio via a wireless network 134. The wireless radio 130, and corresponding wireless radios of the PTT switch 14 or radio, are configured to wireless communicate over a wireless network 134. The wireless network 134 may support communication of digital information using any suitable wireless access technology including, for example, any combination of Intra Soldier Wireless (ISW), Bluetooth, Bluetooth Low Energy (BLE), ultra-wideband (UWB), 900 MHz, 2.4 GHz, 5.4 GHz, short-range, long range, Wi-Fi, cellular, personal communication system (PCS), and/or any suitable air interface technology. In certain embodiments, the wireless network 134 may be a personal area network (PAN) or any suitable network. In various embodiments, the MCU 110 is configured to initiate pairing of the wireless radio 130 with corresponding wireless radios of the PTT switch 14, EUD 16, and/or radio in response to user activation of pushbutton 132, which may be any suitable user input device configured to provide a pairing initiation signal to the MCU 110.

The MCU 110 may comprise suitable logic, circuitry, interfaces, and/or code that is operable to control power output to a night vision device interface 140. The MCU 110 is configured to provide a control signal to switch on a load switch circuit 142 to provide power to the night vision device interface 140, and to provide a control signal to switch off the load switch circuit 142 to disconnect the power supply from the night vision device interface 140. The load switch circuit 142 receives power from the battery unit 160 and provides the power to the night vision device interface 140 in response to the control signal from the MCU 110. In a representative embodiment, the EUD device 16 may be configured to set the power control settings implemented by the MCU 110 regarding the power supplied to the night vision device interface 140 by the battery unit 160 via the load switch circuit 142.

In various embodiments, the MCU 110 may be configured to facilitate communication of control signals from the EUD 16 to the night vision device 18, and communication of data signals from the night vision device 18 to the EUD 16. For example, the MCU 110 may receive digital control signals from the wireless radio 130. The digital control signals are processed by the MCU 110 and provided to the night vision device 18 via the night vision device interface 140. The night vision device interface 140 is operable to receive a wired connection from the night vision device 18, such as a plug of a cable. The night vision device interface 140 is configured to provide the digital control signals to the night vision device 18. The night vision device interface 140 may receive digital data signals from the night vision device 18, which are provided to the MCU 110. The MCU 110 may process the digital data signals and provide the digital data signals to the wireless radio 130 for wireless transmission to the EUD 16 via the wireless network 134. The wireless radio 130, and corresponding wireless radio of the EUD 16, are configured to wirelessly communicate the digital control signals and the digital data signals over the wireless network 134.

The MCU 110 may comprise suitable logic, circuitry, interfaces, and/or code that is operable to facilitate communication of control signals from the EUD 16 to helmet worn accessories 20-1, 20-2, and communication of data signals from the helmet worn accessories 20-1, 20-2 to the EUD 16. For example, the MCU 110 may receive digital control signals from the wireless radio 130. The digital control signals are processed by the MCU 110 and provided to the appropriate one of a plurality of USB ports 156-1, 156-2 via a USB hub 150. Although FIG. 1 illustrates two (2) USB ports 156-1, 156-2, unless so claimed, any suitable number of USB ports may be provided. The USB ports 156-, 156-2 are operable to receive a wired connection from a corresponding helmet worn accessory 20-1, 20-2, such as a plug of a USB cable. The USB ports 156-1, 156-2 are configured to provide the appropriate digital control signals from the EUD 16 to the appropriate helmet worn accessory 20-1, 20-2. The USB ports 156-1, 156-2 may receive digital data signals from the helmet worn accessories 20-1, 20-2, which are provided to the MCU 110 via the USB hub 150. The MCU 110 may process the digital data signals and provide the digital data signals to the wireless radio 130 for wireless transmission to the EUD 16 via the wireless network 134. The wireless radio 130, and corresponding wireless radio of the EUD 16, are configured to wirelessly communicate the digital control signals and the digital data signals over the wireless network 134.

The MCU 110 and the USB power delivery (PD) controllers 154-1, 154-2 may be configured to regulate power provided from the USB ports 156-1, 156-2 to the helmet worn accessories 20-1, 20-2, and to regulate power pulled from the helmet worn accessories 20-1, 20-2 to the USB ports 156-1, 156-2. The USB PD controllers 154-1, 154-2 are operable according to the USB Power Delivery standard for regulating the power pushed to and/or pulled from the helmet worn accessories 20-1, 20-2. The MCU 110 is configured to provide a control signal via the USB PD controllers 154-1, 154-2 to switch on an appropriate load switch circuit 152-1, 152-2 to provide power to the corresponding USB port 156-1, 156-2, and to provide a control signal to switch off the appropriate load switch circuit 156-1, 156-2 to disconnect the power supply from the corresponding USB port 156-1, 156-2. In various embodiments, each of the USB ports 156-1, 156-2 are separately controlled to provide power, receive power, or neither provide nor receive power. The load switch circuits 152-1, 152-2 receive power from the battery unit 160 and provide the power to the appropriate helmet worn accessories 20-1, 20-2 in response to the control signal from the MCU 110. In various embodiments, the load switch circuits 152-1, 152-2 receive power from one or both of the helmet worn accessories 20-1, 20-2, which may be used to charge the battery unit 160, for example.

The battery unit 160 may comprise batteries and suitable logic, circuit, interfaces, and/or code configured to turn on/off in response to activation of the power switch 112 and/or control signals from the MCU 110. In various embodiments, the battery unit 160 may be configured to facilitate charging of the batteries. The batteries may be rechargeable and/or replaceable. The batteries may be lithium-ion batteries (e.g., CR123A), alkaline batteries (e.g., AA), and/or any suitable batteries.

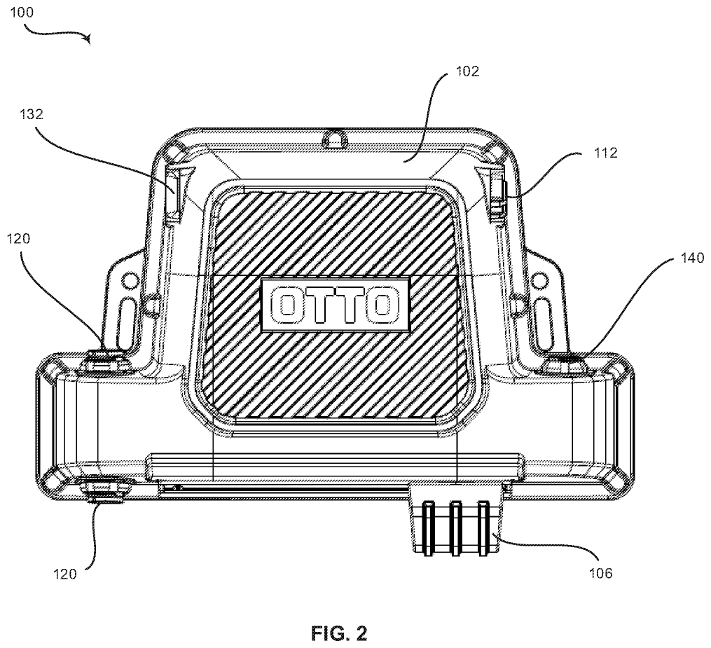

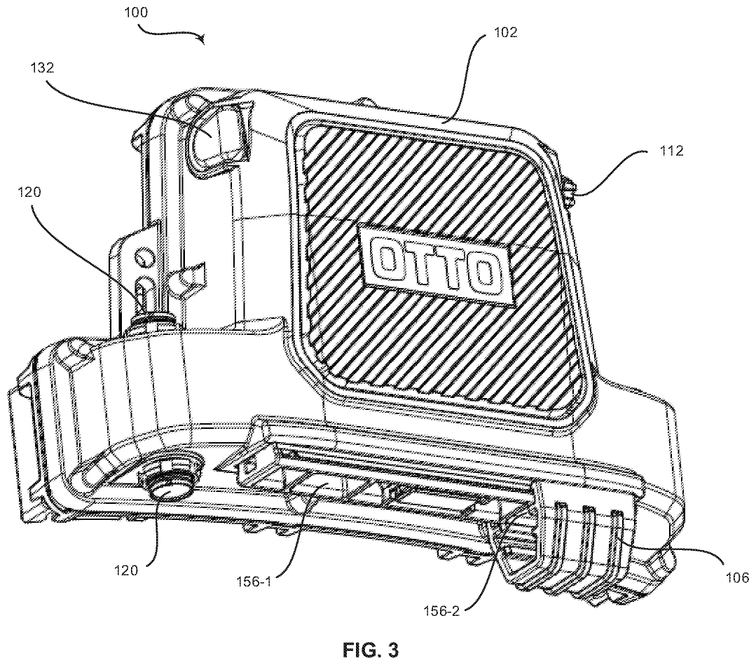

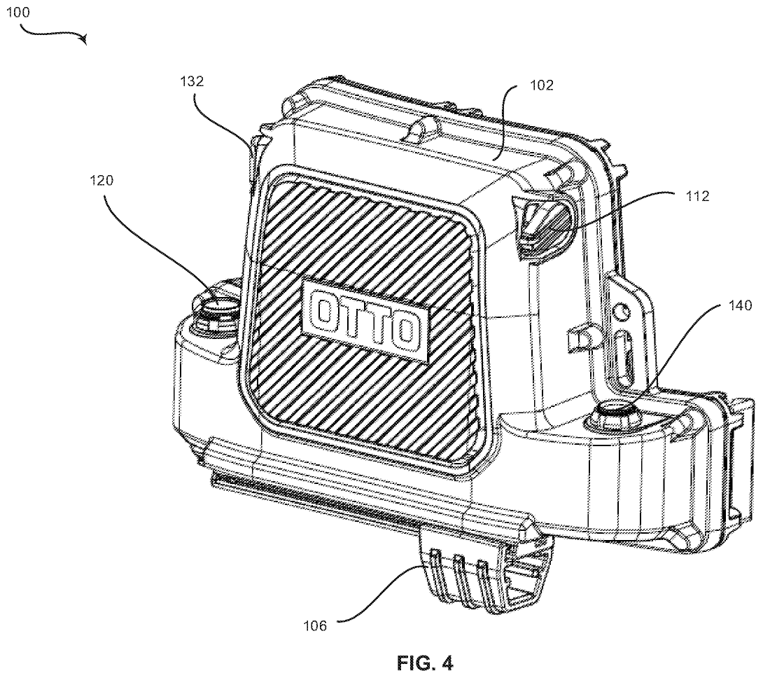

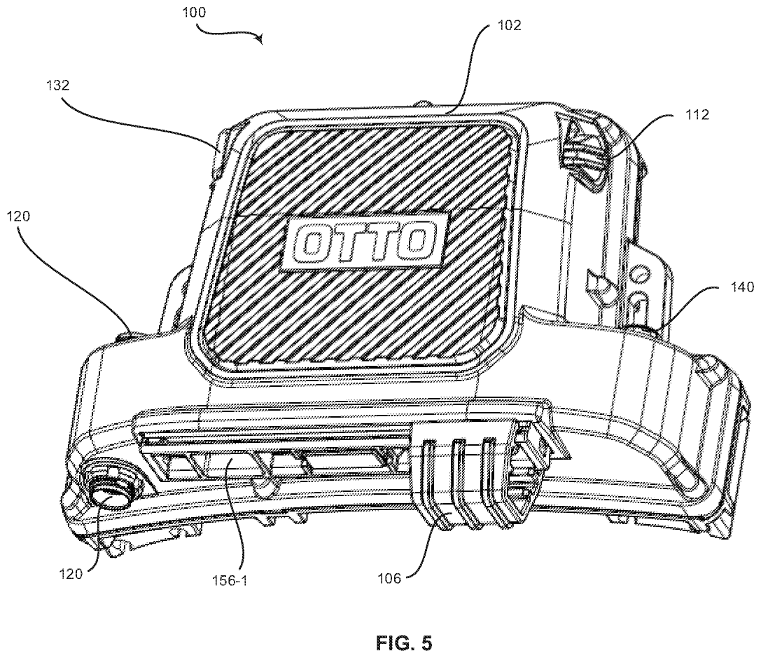

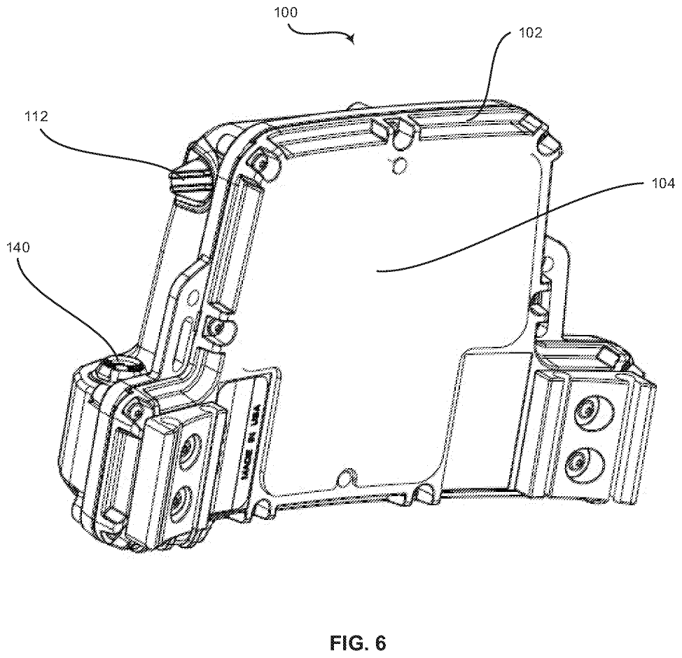

FIG. 2 is a front elevation view of an exemplary helmet power and communications hub 100, in accordance with various embodiments. FIG. 3 is a front, side perspective view of an exemplary helmet power and communications hub 100, in accordance with various embodiments. FIG. 4 is a front, top perspective view of an exemplary helmet power and communications hub 100, in accordance with various embodiments. FIG. 5 is a front, bottom perspective view of an exemplary helmet power and communications hub 100, in accordance with various embodiments. FIG. 6 is a rear, side perspective view of an exemplary helmet power and communications hub 100, in accordance with various embodiments.

Referring to FIGS. 2-6, the helmet power and communications hub 100 comprises a housing 102, one or more cable retention clips 106, a power switch 112, a pushbutton 132, at least one communications headset interface 120, a night vision device interface 140, and USB ports 156-1, 156-2, among other things. The helmet power and communications hub 100 illustrated in FIGS. 2-6 shares various characteristics with the helmet power and communications hub 100 illustrated in FIG. 1 as described above. For example, the MCU 110, audio CODEC 122, amplifier 124, wireless radio 130, load switch circuit 142, USB hub 150, load switch circuits 152-1, 152-2, USB PD controllers 154-1, 154-2, and battery unit 160 shown in FIG. 1 may be disposed in the housing 102 of FIGS. 2-6.

The helmet power and communications hub 100 comprises at least one communications headset interface 120 operable to receive a plug of a cable of a communications headset 12. In various embodiments, the additional communications headset interface 120 may optionally be used to connect a PTT device 14 by wired connection, instead of via corresponding wireless radios 130. The helmet power and communications hub 100 comprises a night vision device interface 140 operable to receive a plug of a cable of a night vision device 18, such as night vision googles (NVG), enhanced night vision googles (ENVG), or a night vision monocle (NVM). The helmet power and communications hub 100 comprises a plurality of USB ports 156-1, 156-2 operable to receive a plug of a USB cable of a helmet worn accessory 20-1, 20-2, such as video cameras, infrared beacons, strobe lights, flashlights, sensors (e.g., blast pressure sensor, chemical biological radiological nuclear (CBRN) sensor, etc.), visual displays, and/or any suitable helmet worn accessories 20-1, 20-2. One or more cable retention clips 106 may be slidably attached to the housing 102. The cable retention clips 106 are operable to slide over a USB plug inserted into one of the USB ports 156-1, 156-2 to secure the USB plug in the USB port 156-1, 156-2.

The helmet power and communications hub 100 comprises a power switch 112, which may be a mechanical rocker switch, or any suitable switch. The power switch 112 is a power disconnect configured to turn on and off the power supplied from the battery unit 160 to the components of the helmet power and communications hub 100. The helmet power and communications hub 100 comprises a pushbutton 132 that may be operable to initiate pairing of the wireless radio 130 disposed within the housing 102 of the helmet power and communications hub 100.

The housing 102 of the helmet power and communications hub 100 may include a rear panel 104 configured to receive an attachment mechanism for fastening to a rear portion of a tactical helmet. For example, the helmet power and communications hub 100 may be configured to be detachably coupled to a back portion of a tactical helmet to provide a counterbalance to the night vision device 18 and/or any helmet worn accessories 20-1, 20-2 mounted to a front portion of the tactical helmet. As an example, the helmet power and communications hub 100 may be detachably coupled to the tactical helmet by hook and loop fasteners, snaps, adhesive tape, and/or any suitable attachment mechanism provided on the rear panel 104 of the housing. In various embodiments, the rear panel 104 of the housing 102 may be removable to access the batteries of the battery unit 160.

Aspects of the present disclosure provide a system 10 comprising a helmet power and communications hub 100 detachably coupled to a tactical helmet for providing wired communication and/or power to helmet-attached accessories 18, 20-1, 20-2 and communication headsets 12, and for providing wireless communication 134 with body-worn accessories 14, 16. The system 10 may comprise a helmet power and communications hub 100 and a push-to-talk (PTT) switch 14. The helmet power and communications hub 100 comprises a housing 102. The helmet power and communications hub 100 comprises a communications headset interface 120 configured to receive a wired connection with a communication headset 12. The helmet power and communications hub 100 comprises a night vision device interface 140 configured to receive a wired connection with a night vision device 18. The helmet power and communications hub 100 comprises a plurality of universal serial bus (USB) ports 156-1, 156-2 configured to receive a wired connection with helmet worn accessories 20-1, 20-2. The helmet power and communications hub 100 comprises a wireless radio 130 disposed within the housing 102 and configured to wirelessly connect to a corresponding wireless radio of a push-to-talk (PTT) switch 14. The helmet power and communications hub 100 comprises a battery unit 160 configured to power the helmet power and communications hub 100. The PTT switch 14 comprises the corresponding wireless radio.

In an exemplary embodiment, the housing 102 comprises an attachment mechanism configured to detachably couple with a corresponding attachment mechanism on a rear portion of a tactical helmet. In a representative embodiment, the attachment mechanism and the corresponding attachment mechanism are hook and loop fasteners. In various embodiments, the wireless radio 130 is configured to communicate via an Intra Soldier Wireless (ISW) network 134. In certain embodiments, the wireless radio 130 is configured to communicate via one of a Bluetooth wireless network 134, a Bluetooth Low Energy (BLE) wireless network 134, an ultra-wideband (UWB) wireless network 134, a 900 MHz wireless network 134, a 2.4 GHz wireless network 134, or a 5.4 GHz wireless network 134. In an exemplary embodiment, the helmet worn accessories 20-1, 20-2 comprises a video camera, an infrared beacon, a strobe light, a flashlight, a sensor, and/or a visual display. In a representative embodiment, the sensor comprises a blast pressure sensor and/or a chemical biological radiological nuclear (CBRN) sensor. In various embodiments, the wireless radio 130 is configured to wirelessly connect to an additional corresponding wireless radio of an end user device (EUD) 16. In certain embodiments, the EUD 16 is a smartphone or a tablet computing device. In an exemplary embodiment, the night vision device 18 is one of night vision googles (NVG), enhanced night vision googles (ENVG), or a night vision monocle (NVM). In a representative embodiment, the helmet power and communications hub 100 comprises a microcontroller unit (MCU) 110 disposed within the housing 102. The MCU 110 is configured to process and route audio signals between the communications headset interface 120 and the wireless radio 130. The MCU 110 is configured to process and route control signals from the wireless radio 130 to at least one of the plurality of USB ports 156-1, 156-2. The MCU 110 is configured to process and route data signals from the plurality of USB ports156-1, 156-2 to the wireless radio 130. The MCU 110 is configured to control power distribution from the battery unit 160 to the night vision device interface 140 and the plurality of USB ports 156-1, 156-2.

Various embodiments provide a helmet power and communications hub 100 detachably coupled to a tactical helmet for providing wired communication and/or power to helmet-attached accessories 18, 20-1, 20-2 and communication headsets 12, and for providing wireless communication 134 with body-worn accessories 14, 16. The helmet power and communications hub 100 comprises a housing 102. The helmet power and communications hub 100 comprises a communications headset interface 120 configured to receive a wired connection with a communication headset 12. The helmet power and communications hub 100 comprises a night vision device interface 140 configured to receive a wired connection with a night vision device 18. The helmet power and communications hub 100 comprises a plurality of universal serial bus (USB) ports 156-1, 156-2 configured to receive a wired connection with helmet worn accessories 20-1, 20-2. The helmet power and communications hub 100 comprises a wireless radio 130 disposed within the housing 102 and configured to wirelessly connect to a corresponding wireless radio of a push-to-talk (PTT) switch 14. The helmet power and communications hub 100 comprises a battery unit 160 configured to power the helmet power and communications hub 100. The helmet power and communications hub 100 comprises a microcontroller unit (MCU) 110 disposed within the housing 102. The MCU 110 is configured to process and route audio signals between the communications headset interface 120 and the wireless radio 130. The MCU 110 is configured to process and route control signals from the wireless radio 130 to at least one of the plurality of USB ports 156-1, 156-2. The MCU 110 is configured to process and route data signals from the plurality of USB ports 156-1, 156-2 to the wireless radio 130. The MCU 110 is configured to control power distribution from the battery unit 160 to the night vision device interface 140 and the plurality of USB ports 156-1, 156-2.

In a representative embodiment, the housing 102 comprises an attachment mechanism configured to detachably couple with a corresponding attachment mechanism on a rear portion of a tactical helmet. In various embodiments, the attachment mechanism and the corresponding attachment mechanism are hook and loop fasteners. In certain embodiments, the wireless radio 130 is configured to communicate via one of an Intra Soldier Wireless (ISW) network 134, a Bluetooth wireless network 134, a Bluetooth Low Energy (BLE) wireless network 134, an ultra-wideband (UWB) wireless network 134, a 900 MHz wireless network 134, a 2.4 GHz wireless network 134, or a 5.4 GHz wireless network 134. In an exemplary embodiment, the wireless radio 130 is configured to wirelessly connect to an additional corresponding wireless radio of an end user device (EUD) 16. The EUD 16 is a smartphone or a tablet computing device. In a representative embodiment, the helmet power and communications hub 100 comprises at least one cable retention clip 106 slidably attached to the housing 102 and operable to secure a USB cable in one of the plurality of USB ports 156-1, 156-2. In various embodiments, the helmet power and communications hub 100 comprises a pushbutton 132 operable to initiate pairing of the wireless radio 130. In certain embodiments, the helmet power and communications hub 100 comprises a power switch 112 operable to turn on and off the power provided by the battery unit 160 to the helmet power and communications hub 100. In an exemplary embodiment, the MCU 110 is further configured to process and route control signals from the wireless radio 130 to the night vision device interface 140. The MCU 110 is further configured to process and route data signals from the night vision device interface 140 to the wireless radio 130.

As utilized herein the term “circuitry” refers to physical electronic components (i.e. hardware) and any software and/or firmware (“code”) which may configure the hardware, be executed by the hardware, and or otherwise be associated with the hardware. As used herein, for example, a particular processor and memory may comprise a first “circuit” when executing a first one or more lines of code and may comprise a second “circuit” when executing a second one or more lines of code. As utilized herein, “and/or” means any one or more of the items in the list joined by “and/or”. As an example, “x and/or y” means any element of the three-element set {(x), (y), (x, y)}. As another example, “x, y, and/or z” means any element of the seven-element set {(x), (y), (z), (x, y), (x, z), (y, z), (x, y, z)}. As utilized herein, the term “exemplary” means serving as a non-limiting example, instance, or illustration. As utilized herein, the terms “e.g.,” and “for example” set off lists of one or more non-limiting examples, instances, or illustrations. As utilized herein, circuitry or other structure is “operable” or “configured” to perform a function whenever the circuitry or other structure comprises the necessary hardware and code (if any is necessary) to perform the function, regardless of whether performance of the function is disabled, or not enabled, by some user-configurable setting.

Other embodiments of the disclosure may provide a computer readable device and/or a non-transitory computer readable medium, and/or a machine readable device and/or a non-transitory machine readable medium, having stored thereon, a machine code and/or a computer program having at least one code section executable by a machine and/or a computer, thereby causing the machine and/or computer to perform the steps as described herein for providing wired communication and/or power to helmet-attached accessories and communication headsets, and for providing wireless communication with body-worn accessories.

Accordingly, the present disclosure may be realized in hardware, software, or a combination of hardware and software. The present disclosure may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present disclosure may also be embedded in a computer program product, which comprises all the features enabling the implementation of the methods described herein, and which when loaded in a computer system is able to carry out these methods. Computer program in the present context means any expression, in any language, algorithm, code or notation, of a set of instructions intended to cause a system having an information processing capability to perform a particular function either directly or after either or both of the following: a) conversion to another language, code or notation; b) reproduction in a different material form.

While the present disclosure has been described with reference to certain embodiments, it will be understood by those skilled in the art that various changes may be made and equivalents may be substituted without departing from the scope of the present disclosure. In addition, many modifications may be made to adapt a particular situation or material to the teachings of the present disclosure without departing from its scope. Therefore, it is intended that the present disclosure not be limited to the particular embodiment disclosed, but that the present disclosure will include all embodiments falling within the scope of the appended claims.

What it claimed is:

1. A system comprising:
a helmet power and communications hub comprising:
a housing;
a communications headset interface configured to receive a wired connection with a communication headset;
a night vision device interface configured to receive a wired connection with a night vision device;
a plurality of universal serial bus (USB) ports configured to receive a wired connection with helmet worn accessories;
a wireless radio disposed within the housing and configured to wirelessly connect to a corresponding wireless radio of a push-to-talk (PTT) switch; and
a battery unit configured to power the helmet power and communications hub; and the PTT switch comprising the corresponding wireless radio.

2. The system of claim 1, wherein the housing comprises an attachment mechanism configured to detachably couple with a corresponding attachment mechanism on a rear portion of a tactical helmet.

3. The system of claim 2, wherein the attachment mechanism and the corresponding attachment mechanism are hook and loop fasteners.

4. The system of claim 1, wherein the wireless radio is configured to communicate via an Intra Soldier Wireless (ISW) network.

5. The system of claim 1, wherein the wireless radio is configured to communicate via one of:
a Bluetooth wireless network,
a Bluetooth Low Energy (BLE) wireless network,
an ultra-wideband (UWB) wireless network,
a 900 MHz wireless network,
a 2.4 GHz wireless network, or
a 5.4 GHz wireless network.

6. The system of claim 1, wherein the helmet worn accessories comprises:
a video camera,
an infrared beacon,
a strobe light,
a flashlight,
a sensor, and/or
a visual display.

7. The system of claim 6, wherein the sensor comprises a blast pressure sensor and/or a chemical biological radiological nuclear (CBRN) sensor.

8. The system of claim 1, wherein the wireless radio is configured to wirelessly connect to an additional corresponding wireless radio of an end user device (EUD).

9. The system of claim 8, wherein the EUD is a smartphone or a tablet computing device.

10. The system of claim 1, wherein the night vision device is one of night vision googles (NVG), enhanced night vision googles (ENVG), or a night vision monocle (NVM).

11. The system of claim 1, wherein the helmet power and communications hub comprises a microcontroller unit (MCU) disposed within the housing and configured to:
process and route audio signals between the communications headset interface and the wireless radio;
process and route control signals from the wireless radio to at least one of the plurality of USB ports;
process and route data signals from the plurality of USB ports to the wireless radio; and
control power distribution from the battery unit to the night vision device interface and the plurality of USB ports.

12. A helmet power and communications hub comprising:
a housing;
a communications headset interface configured to receive a wired connection with a communication headset;
a night vision device interface configured to receive a wired connection with a night vision device;
a plurality of universal serial bus (USB) ports configured to receive a wired connection with helmet worn accessories;
a wireless radio disposed within the housing and configured to wirelessly connect to a corresponding wireless radio of a push-to-talk (PTT) switch;
a battery unit configured to power the helmet power and communications hub; and
a microcontroller unit (MCU) disposed within the housing and configured to:
process and route audio signals between the communications headset interface and the wireless radio;
process and route control signals from the wireless radio to at least one of the plurality of USB ports;
process and route data signals from the plurality of USB ports to the wireless radio; and
control power distribution from the battery unit to the night vision device interface and the plurality of USB ports.

13. The helmet power and communications hub of claim 12, wherein the housing comprises an attachment mechanism configured to detachably couple with a corresponding attachment mechanism on a rear portion of a tactical helmet.

14. The helmet power and communications hub of claim 13, wherein the attachment mechanism and the corresponding attachment mechanism are hook and loop fasteners.

15. The helmet power and communications hub of claim 12, wherein the wireless radio is configured to communicate via one of:
an Intra Soldier Wireless (ISW) network,
a Bluetooth wireless network,
a Bluetooth Low Energy (BLE) wireless network,
an ultra-wideband (UWB) wireless network,
a 900 MHz wireless network,
a 2.4 GHz wireless network, or
a 5.4 GHz wireless network.

16. The helmet power and communications hub of claim 12, wherein:
the wireless radio is configured to wirelessly connect to an additional corresponding wireless radio of an end user device (EUD), and
the EUD is a smartphone or a tablet computing device.

17. The helmet power and communications hub of claim 12, comprising at least one cable retention clip slidably attached to the housing and operable to secure a USB cable in one of the plurality of USB ports.

18. The helmet power and communications hub of claim 12, comprising a pushbutton operable to initiate pairing of the wireless radio.

19. The helmet power and communications hub of claim 12, comprising a power switch operable to turn on and off the power provided by the battery unit to the helmet power and communications hub.

20. The helmet power and communications hub of claim 12, wherein the MCU is further configured to:
process and route control signals from the wireless radio to the night vision device interface; and
process and route data signals from the night vision device interface to the wireless radio.
